(19) United States
(12) Patent Application Publication
(10) Pub. No.: US 2019/0302313 A1
(43) Pub. Date: Oct. 3, 2019

(54) ARTICLE COATED WITH AN INTERFERENCE COATING HAVING PROPERTIES THAT ARE STABLE OVER TIME

(71) Applicants: CORPORATION DE L'ECOLE POLYTECHNIQUE DE MONTREAL, Montreal (CA); ESSILOR INTERNATIONAL, Charenton Le Pont (FR)

(72) Inventors: Ludvik Martinu, Montreal (CA); Jolanta Klemberg-Sapieha, Montreal (CA); Oleg Zabeida, Montreal (CA); Sebastien Chiarotto, Charenton Le Pont (FR); Karin Scherer, Charenton Le Pont (FR)

(21) Appl. No.: 16/283,343

(22) Filed: Feb. 22, 2019

Related U.S. Application Data
(63) Continuation of application No. 14/369,009, filed on Jun. 26, 2014, now abandoned.

(30) Foreign Application Priority Data
Dec. 28, 2011 (FR) 1162492

(51) Int. Cl. G02B 1/11; G02B 1/111; G02B 1/115; G02C 7/02; C03C 17/38; G02B 1/16; G02B 1/18; G02B 1/14

(52) U.S. Cl. CPC G02B 1/11; G02B 1/111; G02B 1/115; G02C 7/022; C03C 2217/948; G02B 1/16; G02B 1/18; G02B 1/14; C03C 2217/734; C03C 17/38

(57) ABSTRACT

The invention relates to an article comprising a substrate having at least one main surface coated with a multilayer interference coating, said coating containing a layer A having a refractive index less than or equal to 1.55. The article is characterised in that: layer A forms either the outer interference coating layer or an intermediate layer that is in direct contact with the outer interference coating layer, said outer interference coating layer being a layer B having a refractive index less than or equal to 1.55; layer A is obtained by ion beam deposition of activated species from at least one compound C in gaseous form and containing in its structure at least one silicon atom, at least one carbon atom, at least one hydrogen atom and, optionally, at least one nitrogen atom and/or at least one oxygen atom, layer A being deposited in the presence of nitrogen and/or oxygen when compound A does not contain nitrogen and/or oxygen; and layer A is not formed from inorganic precursor compounds.

### CROSS-REFERENCE TO RELATED APPLICATIONS

This application is a continuation of U.S. application Ser. No. 14/369,009, filed Jun. 26, 2014, which is a national phase application under 35 U.S.C. § 371 of International Application No. PCT/FR2012/053092 filed 27 Dec. 2012, which claims priority to French Patent Application No. 1162492 filed 28 Dec. 2011. The entire contents of each of the above-referenced disclosures is specifically incorporated herein by reference without disclaimer.

### BACKGROUND OF THE INVENTION

### A. Field of the Invention

The present invention generally relates to an article, preferably an optical article, especially an ophthalmic lens, possessing an interference coating, preferably an antireflection coating, the optical properties of which are stable over time, and which furthermore possesses improved thermomechanical properties, and to a process for producing such an article.

### B. Description of Related Art

It is known to treat ophthalmic glasses, whether they are mineral or organic glasses, in such a way as to prevent the formation of parasitic reflections that could irritate the wearer of the lens and the people they interact with. The lens is then provided with a monolayer or multilayer antireflection coating generally made of (a) mineral material(s).

During the production of an antireflection coating, target performance criteria are generally chosen, namely the effectiveness of the antireflection coating defined by the reflection coefficients Rₘ and Rᵥ, and its residual color in reflection, essentially characterized by its hue angle h and chroma C*. The latter two parameters guarantee the aesthetic quality of the anti-reflection treatment for the wearer and the people they interact with.

However, the optical properties of the layers of antireflection coatings, and more generally the optical properties of the layers of interference coatings, in particular the properties of silica layers, vary over time, to the point that their effectiveness 42810363.1 characteristics but above all appearance characteristics may differ between the moment when the coating is formed on the article and the moment when the latter is sold, if the glass has been held in stock, and/or during use of the article by the wearer after sale.

One way of solving the first problem consists in estimating how the properties of the antireflection coating will vary over time and then producing an antireflection coating that is different from that desired but that will change over time to reach the targeted values, during its storage.

However, since the variation over time is empirical and not always modelable, the problem of selling lenses treated with antireflection coatings having the targeted performance criteria remains.

Moreover, for prescription glasses, sold to the wearer in the days following their manufacture, the problem of optical property modification during use by the wearer remains to be solved.

Thus, it would be desirable to develop novel interference coatings, in particular antireflection coatings, that are less susceptible to variation in their optical properties over time, while substantially preserving or improving the other properties of these interference coatings, such as their mechanical properties and adherence.

According to the invention, the problem is solved by depositing, as an external layer of the interference coating, a low refraction index layer formed by deposition, under an ion beam, of a layer obtained exclusively from organic precursor materials in gaseous form.

U.S. Pat. No. 6,919,134 describes an optical article comprising an antireflection coating containing at least one what is called “hybrid” layer obtained by coevaporation of an organic compound and an inorganic compound, thereby providing the coating with a better adhesion, a better thermal resistance and a better abrasion resistance. The antireflection coating preferably contains two “hybrid” layers, one in an internal position and the another in an external position. These layers are generally deposited by ion-assisted coevaporation, typically of silica and of a modified silicone oil.

Patent application JP 2007-078780 describes a spectacle glass comprising a multilayer antireflection coating, the external layer of which is what is called an “organic” low refractive index layer. This layer is deposited by wet processing (spin coating or dip coating), whereas the inorganic layers of the antireflection coating are deposited by ion-assisted vacuum deposition. The patent application indicates that such an antireflection stack possesses a better thermal resistance than an antireflection coating composed exclusively of inorganic layers. Said “organic” layer preferably contains a mixture of silica particles and an organosilane binder such as γ-glycidoxypropyltrimethoxysilane.

Patent application JP 05-323103 describes the incorporation of an organic fluorocompound in the last layer of an optical multilayer stack containing layers of SiO₂ and of TiO₂, with a view to making it hydrophobic and thus minimizing changes in its optical characteristics caused by the absorption of water. The fluorine-containing layer is obtained by vapor phase deposition of the constituent material of the layer in an atmosphere composed of a fluorine-containing precursor, which may be tetrafluoroethylene or a fluoroalkyl silane.

### SUMMARY OF THE INVENTION

The main objective of the invention is the production of interference coatings, in particular antireflection coatings, the optical properties of which, in particular the chroma of which (wearers being more sensitive to this parameter), are more stable over time than known interference coatings. Such interference coatings possess their target characteristics from the end of the deposition of the various layers of the stack, thereby making it possible to guarantee their performance and simplify quality control. This technical problem is not addressed in the patent or patent applications cited above.

Moreover, during the trimming and fitting of a glass at an opticians, the glass undergoes mechanical deformations that may produce cracks in mineral interference coatings, in particular when the operation is not carried out with care. Similarly, thermal stresses (heating of the frame) may produce cracks in the interference coating. Depending on the number and the size of the cracks, the latter may mar the field of view of the wearer and prevent the glass from being sold.

Thus, another objective of the invention is to obtain interference coatings having improved thermomechanical properties, while preserving good adherence properties. In particular, the invention relates to articles possessing an improved critical temperature, i.e. having a good resistance to cracking when they are subjected to a temperature increase.

Another objective of the invention is to provide a process for manufacturing an interference coating, which process is simple, easy to implement and reproducible.

The inventors have discovered that modifying the nature of the external layer of the interference coating, which is generally a low refractive index layer, typically a silica layer, allows the targeted objectives to be achieved. According to the invention, this layer is formed by deposition, under an ion beam, of activated species, in gaseous form, which species are obtained exclusively from organic precursor materials.

Thus, the targeted aims are achieved according to the invention by an article comprising a substrate having at least one main surface coated with a multilayer interference coating, said coating containing a layer A having a refractive index lower than or equal to 1.55, which is:
either the external layer of the interference coating,
or an intermediate layer making direct contact with the external layer of the interference coating, this external layer of the interference coating being, in this second case, a layer B having a refractive index lower than or equal to 1.55, and said layer A was obtained by deposition, under an ion beam, of activated species issued from at least one compound C in gaseous form, containing in its structure at least one silicon atom, at least one carbon atom, at least one hydrogen atom and, optionally, at least one nitrogen atom and/or at least one oxygen atom, the deposition of said layer A being carried out in the presence of nitrogen and/or oxygen when the compound A does not contain nitrogen and/or oxygen; and in that the layer A is not formed from inorganic precursor compounds.

The invention also relates to a process for manufacturing such an article, comprising at least the following steps:
providing an article comprising a substrate having at least one main surface,
depositing, on said main surface of the substrate, a multilayer interference coating, said coating containing a layer A having a refractive index lower than or equal to 1.55, which is:
   either the external layer of the interference coating,
   or an intermediate layer making direct contact with the external layer of the interference coating, this external layer of the interference coating being a layer B having a refractive index lower than or equal to 1.55,
recovering an article comprising a substrate having a main surface coated with said interference coating that contains said layer A, said layer A having been obtained by deposition, under an ion beam, of activated species issued from at least one compound C in gaseous form, containing in its structure at least one silicon atom, at least one carbon atom, at least one hydrogen atom and, optionally, at least one nitrogen atom and/or at least one oxygen atom, the deposition of said layer A being carried out in the presence of nitrogen and/or oxygen when the compound A does not contain nitrogen and/or oxygen, the layer A not being formed from inorganic precursor compounds.

The invention will be described in greater detail with reference to the appended drawing, in which FIG. 1 schematically shows a deformation experienced by a glass and the way in which this deformation D is measured in the bending resistance test described in the experimental section.

In the present application, when an article has one or more coatings on its surface, the expression “to deposit a layer or a coating on the article” is understood to mean that a layer or a coating is deposited on the uncovered (exposed) surface of the external coating of the article, i.e. its coating furthest from the substrate.

A coating that is “on” a substrate or that has been deposited “on” a substrate is defined as a coating that (i) is positioned above the substrate, (ii) does not necessarily make contact with the substrate, i.e. one or more intermediate coatings may be arranged between the substrate and the coating in question, and (iii) does not necessarily completely cover the substrate (although preferably it will do). When “a layer 1 is located under a layer 2”, it will be understood that the layer 2 is further from the substrate than the layer 1.

The article produced according to the invention comprises a substrate, preferably a transparent substrate, having front and back main faces, at least one of said main faces and preferably both main faces comprising an interference coating.

The “back face” of the substrate (the back face is generally concave) is understood to be the face that, when the article is being used, is closest to the eye of the wearer. Conversely, the “front face” of the substrate (the front face is generally convex) is understood to be the face that, when the article is being used, is furthest from the eye of the wearer.

Although the article according to the invention may be any type of article, such as a screen, a glazing unit, a pair of protective glasses especially used in a working environment, or a mirror, it is preferably an optical article, more preferably an optical lens, and even more preferably an ophthalmic lens for a pair of spectacles, or a blank optical or ophthalmic lens such as a semi-finished optical lens, and in particular a spectacle glass. The lens may be a polarized or tinted lens or a photochromic lens. Preferably, the ophthalmic lens according to the invention has a high transmission.

The interference coating according to the invention may be formed on at least one of the main faces of a bare substrate, i.e. an uncoated substrate, or on at least one of the main faces of a substrate already coated with one or more functional coatings.

The substrate of the article according to the invention may preferably be made of an organic glass, for example of an organic glass made of thermoplastic or thermosetting plastic. This substrate may be chosen from the substrates mentioned in patent application WO 2008/062142, and may for example be a substrate obtained by (co)polymerization of diethyleneglycol bis-allylcarbonate, a poly(thio)urethane substrate or a substrate made of (thermoplastic) bis-phenol-A polycarbonate (PC).

Before the interference coating is deposited on the substrate, which is optionally coated, for example with an anti-abrasion and/or anti-scratch coating, it is common to subject the surface of said optionally coated substrate to a physical or chemical activation treatment intended to increase the adhesion of the interference coating. This pre-treatment is generally carried out under vacuum. It may be a question of a bombardment with energetic and/or reactive species, for example an ion beam (ion pre-cleaning or IPC) or an electron beam, a corona discharge treatment, a glow discharge treatment, a UV treatment or treatment in a vacuum plasma, generally an oxygen or argon plasma. It may also be a question of an acidic or basic surface treatment and/or a treatment with solvents (water or organic solvent(s)). Several of these treatments may be combined. By virtue of these cleaning treatments, the cleanliness and the reactivity of the surface of the substrate are optimized.

The term “energetic species” (and/or “reactive species”) are/is particularly understood to mean ionic species having an energy ranging from 1 to 300 eV, preferably from 1 to 150 eV, more preferably from 10 to 150 eV and even more preferably from 40 to 150 eV. The energetic species may be chemical species, such as ions, radicals, or species such as photons or electrons.

The preferred pre-treatment of the surface of the substrate is an ion bombardment treatment carried out by means of an ion gun, the ions being particles formed from gas atoms from which one or more electrons have been stripped. Argon is preferably used as the gas ionized (Ark ions), though oxygen or a mixture of oxygen and argon may also be used, under an acceleration voltage generally ranging from 50 to 200 V, a current density generally contained between 10 and 100 μA/cm² at the activated surface, and generally under a residual pressure in the vacuum chamber possibly ranging from 8×10⁻⁵ mbar to 2×10⁻⁴ mbar.

The article according to the invention comprises an interference coating, preferably formed on an anti-abrasion coating. Anti-abrasion coatings based on epoxysilane hydrolysates containing at least two and preferably at least three hydrolysable groups bonded to the silicon atom are preferred.

The hydrolysable groups are preferably alkoxysilane groups.

The interference coating may be any interference coating conventionally used in the field of optics, in particular ophthalmic optics, provided that it contains a layer A formed by depositing, under an ion beam, activated species issued from an organic derivative of silicon, in gaseous form. The interference coating may be, nonlimitingly, an antireflection coating, a reflective (mirror) coating, an infrared filter or an ultraviolet filter, but is preferably an antireflection coating.

An antireflection coating is a coating, deposited on the surface of an article, which improves the antireflection properties of the final article. It reduces the reflection of light at the article/air interface over a relatively broad portion of the visible spectrum.

As is well known, these interference (preferably antireflection) coatings conventionally contain a monolayer or multilayer stack of dielectric materials. They are preferably multilayer coatings containing high refractive index (HI) layers and low refractive index (LI) layers.

In the present patent application, a layer of the interference coating is said to be a high refractive index layer when its refractive index is higher than 1.55, preferably higher than or equal to 1.6, more preferably higher than or equal to 1.8 and even more preferably higher than or equal to 2.0. A layer of an interference coating is said to be a low refractive index layer when its refractive index is lower than or equal to 1.55, preferably lower than or equal to 1.50 and more preferably lower than or equal to 1.45. Unless otherwise indicated, the refractive indices to which reference is made in the present invention are expressed at 25° C. for a wavelength of 630 nm.

The HI layers are conventional high refractive index layers, well known in the art. They generally contain one or more mineral oxides such as, nonlimitingly, zirconia (ZrO₂), titanium oxide (TiO₂), tantalum pentoxide (Ta₂O₅), neodymium oxide (Nd₂O₅), hafnium oxide (HfO₂), praseodymium oxide (Pr₂O₃), praseodymium titanate (PrTiO₃), La₂O₃, Nb₂O₅, Y₂O₃, indium oxide In₂O₃, or tin oxide SnO₂. Preferred materials are TiO₂, Ta₂O₅, PrTiO₃, ZrO₂, SnO₂, In₂O₃ and their mixtures.

The LI layers are also well known layers and may contain, nonlimitingly, SiO₂, MgF₂, ZrF₄ alumina (Al₂O₃) in a small proportion, AlF₃ and their mixtures, but are preferably SiO₂ layers. Layers made of SiOF (fluorine-doped SiO₂) may also be used. Ideally, the interference coating of the invention comprises no layer containing a mixture of silica and alumina.

Generally, the HI layers have a physical thickness ranging from 10 nm to 120 nm and the LI layers have a physical thickness ranging from 10 nm to 100 nm.

The total thickness of the interference coating is preferably lower than 1 micron, more preferably lower than or equal to 800 nm and even more preferably lower than or equal to 500 nm. The total thickness of the interference coating is generally larger than 100 nm, and preferably larger than 150 nm.

Even more preferably, the interference coating, which is preferably an antireflection coating, contains at least two low refractive index (LI) layers and at least two high refractive index (HI) layers. The total number of layers in the interference coating is preferably lower than or equal to 8 and more preferably lower than or equal to 6.

The HI and LI layers need not be alternated in the interference coating though they may be in one embodiment of the invention. Two (or more) HI layers may be deposited on each other just as two (or more) LI layers may be deposited on each other.

According to one embodiment of the invention, the interference coating comprises an underlayer. In this general case, this underlayer forms the first layer of the interference coating in the order of deposition of the layers, i.e. the underlayer is the layer of the interference coating that makes contact with the underlying coating (which is generally an anti-abrasion and/or anti-scratch coating), or with the substrate when the interference coating is deposited directly on the substrate.

The expression “underlayer of the interference coating” is understood to mean a coating of relatively large thickness used with the aim of improving the resistance of said coating to abrasion and/or scratches and/or to promote adhesion of the coating to the substrate or to the underlying coating. The underlayer according to the invention may be chosen from the underlayers described in patent application WO 2010/109154.

Preferably, the underlayer is between 100 to 200 nm in thickness. It is preferably exclusively mineral in nature and is preferably made of silica SiO₂.

The article of the invention may be made antistatic by incorporating at least one electrically conductive layer into the interference coating. The term “antistatic” is understood to mean the property of not storing and/or building up an appreciable electrostatic charge. An article is generally considered to have acceptable antistatic properties when it does not attract and hold dust and small particles after one of its surfaces has been rubbed with an appropriate cloth.

The electrically conductive layer may be located in various places in the interference coating, provided that this does not interfere with the antireflection properties of the latter. It may for example be deposited on the underlayer of the interference coating, if an underlayer is present. It is preferably located between two dielectric layers of the interference coating, and/or under a low refractive index layer of the interference coating.

The electrically conductive layer must be sufficiently thin not to decrease the transparency of the interference coating. Generally, its thickness ranges from 0.1 to 150 nm and preferably from 0.1 to 50 nm depending on its nature. A thickness lower than 0.1 nm generally does not allow sufficient electrical conductivity to be obtained, whereas a thickness larger than 150 nm generally does not allow the required transparency and low-absorption properties to be obtained.

The electrically conductive layer is preferably made from an electrically conductive and highly transparent material. In this case, its thickness preferably ranges from 0.1 to 30 nm, more preferably from 1 to 20 nm and even more preferably from 2 to 15 nm. The electrically conductive layer preferably contains a metal oxide chosen from indium oxide, tin oxide, zinc oxide and their mixtures. Indium tin oxide (tin-doped indium oxide, In₂O₃:Sn), indium oxide (In₂O₃), and tin oxide SnO₂ are preferred. According to one optimal embodiment, the electrically conductive and optically transparent layer is a layer of indium tin oxide (ITO).

Generally, the electrically conductive layer contributes to the antireflection properties obtained and forms a high refractive index layer in the interference coating. This is the case for layers made from an electrically conductive and highly transparent material such as layers of ITO.

The electrically conductive layer may also be a very thin layer of a noble metal (Ag, Au, Pt, etc.) typically lower than 1 nm in thickness and preferably less than 0.5 nm in thickness.

The various layers of the interference coating (including the optional antistatic layer) other than the layer A are preferably deposited by vacuum deposition using one of the following techniques: i) evaporation, optionally ion-assisted evaporation, ii) ion-beam sputtering, iii) cathode sputtering or iv) plasma-enhanced chemical vapor deposition. These various techniques are described in the books “Thin Film Processes” and “Thin Film Processes II”, edited by Vossen and Kern, Academic Press, 1978 and 1991, respectively. The vacuum evaporation technique is particularly recommended.

Preferably, each of the layers of the interference coating is deposited by vacuum evaporation.

The layers A and B of the interference coating (the layer B being optional) will now be described. Within the context of the invention these layers are low refractive index layers since their refractive index is 1.55. In some embodiments of the invention the refractive index of the layer A is preferably higher than or equal to 1.45, more preferably higher than 1.47, even more preferably higher than or equal to 1.48 and ideally higher than or equal to 1.49.

The layer A is deposited by depositing, under an ion beam, activated species issued from at least one compound C, in gaseous form, containing in its structure at least one silicon atom, at least one carbon atom, at least one hydrogen atom and, optionally, at least one nitrogen atom and/or at least one oxygen atom, the deposition of said layer A being carried out in the presence of nitrogen and/or oxygen when the compound A does not contain nitrogen and/or oxygen.

Preferably, the deposition is carried out in a vacuum chamber comprising an ion gun directed toward the substrates to be coated, which emits, toward said substrates, a beam of positive ions generated in a plasma within the ion gun. Preferably, the ions issued from the ion gun are particles formed from gas atoms from which one or more electrons have been stripped, the gas being a noble gas, oxygen or a mixture of two or more of these gases.

A gaseous precursor, the compound C, is introduced into the vacuum chamber, preferably in the direction of the ion beam, and is activated under the effect of the ion gun.

Without wanting to be limited to any one theory, the inventors think that the plasma of the ion gun projects ions into a zone located a certain distance in front of the gun, without however reaching the substrates to be coated, and that activation/disassociation of the precursor compound C takes place preferentially in this zone, more generally near the ion gun, and to a lesser extent in the ion gun.

This deposition technique using an ion gun and a gaseous precursor, sometimes referred to as “ion beam deposition”, is especially described in patent U.S. Pat. No. 5,508,368.

According to the invention, the ion gun is preferably the only place in the chamber where a plasma is generated.

The ions may, if required, be neutralized before they exit the ion gun. In this case, the bombardment is still considered to be ion bombardment. The ion bombardment causes atomic rearrangement in and a densification of the layer being deposited, tamping it down while it is being formed.

During the implementation of the process according to the invention, the surface to be treated is preferably bombarded by ions with a current density generally comprised between 20 and 1000 μA/cm², preferably between 30 and 500 μA/cm², more preferably between 30 and 200 μA/cm² at the activated surface and generally under a residual pressure in the vacuum chamber possibly ranging from 6×10⁻⁵ mbar to 2×10⁻⁴ mbar and preferably from 8×10⁻⁵ mbar to 2×10⁻⁴ mbar. An argon and/or oxygen ion beam is preferably used. When a mixture of argon and oxygen is used the Ar:O₂ molar ratio is preferably 1, more preferably 0.75 and even more preferably 0.5. This ratio may be controlled by adjusting the gas flow rates in the ion gun. The argon flow rate preferably ranges from 0 to 30 sccm. The oxygen O₂ flow rate preferably ranges from 5 to 30 sccm, and rises in proportion to the flow rate of the precursor compound of the layer A.

The ions of the ion beam, which are preferably issued from an ion gun used during the deposition of the layer A, preferably have an energy ranging from 75 to 150 eV, more preferably from 80 to 140 eV and even more preferably from 90 to 110 eV.

The activated species formed are typically radicals or ions.

The technique of the invention differs from a deposition by means of a plasma (PECVD for example) in that it involves a bombardment, by means of an ion beam, of the layer A being formed, which beam is preferably emitted by an ion gun.

In addition to the ion bombardment during the deposition, it is possible to carry out a plasma treatment, optionally concomitant with the deposition under ion beam, of the layer A.

Preferably, the layer is deposited without the assistance of a plasma at the substrate level.

Apart from the layer A, other layers of the interference coating may be deposited under an ion beam.

The evaporation of the precursor materials of the layer A, carried out under vacuum, may be achieved using a joule heat source.

The precursor material of the layer A contains at least one compound C that is organic in nature and that contains, in its structure, at least one silicon atom, at least one carbon atom, at least one hydrogen atom and optionally at least one nitrogen atom and/or at least one oxygen atom.

Preferably, the compound C contains at least one nitrogen atom and/or at least one oxygen atom and preferably at least one oxygen atom.

The concentration of each chemical element (Si, O, C, H) in the layer A may be determined using the Rutherford backscattering spectrometry technique (RBS) and elastic recoil detection analysis (ERDA).

The atomic percentage of carbon atoms in the layer A preferably ranges from 10 to 25% and more preferably from 15 to 25%. The atomic percentage of hydrogen atoms in the layer A preferably ranges from 10 to 40% and more preferably from 10 to 20%. The atomic percentage of silicon atoms in the layer A preferably ranges from 5 to 30% and more preferably from 15 to 25%. The atomic percentage of oxygen atoms in the layer A preferably ranges from 20 to 60% and more preferably from 35 to 45%.

The following compounds are nonlimiting examples of cyclic and noncyclic organic precursor compounds of the layer A: octamethylcyclotetrasiloxane (OMCTS), decamethylcyclopentasiloxane, dodecamethylcyclohexasiloxane, hexaméthyl cyclotrisiloxane, hexamethyldisiloxane (HMDSO), octamethyltrisiloxane, decamethyltetrasiloxane, tetraethoxysilane, vinyltrimethylsilane, hexamethyldisilazane, hexamethyldisilane, hexamethylcyclotrisilazane, vinylmethyldiethoxysilane, divinyltetramethyldisiloxane, tetramethyldisiloxane and a tetraalkylsilane such as tetramethyl silane.

The precursor compound of the layer A preferably contains at least one silicon atom bearing at least one preferably C1-C4 alkyl group and more preferably two identical or different preferably C1-C4 alkyl groups, for example a methyl group.

Precursor compounds of the layer A preferably contain an Si—O—Si group and more preferably the following group:

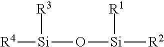

where R¹ to R⁴ independently designate alkyl groups, preferably C1-4 alkyl groups, for example a methyl group.

Preferably, the silicon atom or atoms of the precursor compound of the layer A contain no hydrolysable group. Nonlimiting examples of hydrolysable groups are chloro, bromo, alcoxy and acyloxy groups. Groups containing an Si—O—Si chain are not considered as being “hydrolysable groups” in the context of the invention.

The silicon atom or atoms of the precursor compound of the layer A are preferably only bonded to alkyl groups and/or groups containing an —O—Si or —NH—Si chain so as to form an Si—O—Si or Si—NH—Si group.

The preferred precursor compounds of the layer A are OMCTS and HMDSO. The precursor compound of the layer A is preferably introduced into the vacuum chamber in which articles according to the invention are produced in gaseous form, while controlling its flow rate. In other words, it is preferably not vaporized inside the vacuum chamber. The feed of the precursor compound of the layer A is located a distance away from the exit of the ion gun preferably ranging from 30 to 50 cm.

Preferably, the layer A contains no fluorocompounds. According to the invention, the layer A is not formed from inorganic (mineral) precursor compounds and, in particular, it is not formed from precursors having a metal oxide nature. Therefore, it is particularly different from the “hybrid” layers described in patent application U.S. Pat. No. 6,919,134. Preferably, the layer A does not contain a separate metal oxide phase, and more preferably does not contain any inorganic compounds. In the present application, metalloid oxides are considered to be metal oxides.

The process allowing the interference coating according to the invention to be formed is therefore much simpler and less expensive than processes in which an organic compound and an inorganic compound are coevaporated, such as the process described in patent application U.S. Pat. No. 6,919,134 for example. In practice, co-evaporation processes are very difficult to implement and difficult to control due to reproducibility problems. Specifically, the respective amounts of organic and inorganic compounds present in the deposited layer vary a lot from one operation to another.

Since the layer A is formed by vacuum deposition, it does not contain any silane hydrolysate and therefore differs from sol-gel coatings obtained by liquid processing.

Said layer A either forms the external layer of the interference coating, i.e. the layer of the interference coating furthest from the substrate in the stacking order, or the layer making direct contact with the external layer of the interference coating, this external layer of the interference coating being a layer B having a refractive index lower than or equal to 1.55. In the second case, which is the preferred embodiment, the layer A forms the penultimate layer of the interference coating, in the stacking order.

The layer B preferably contains at least 50 wt % silica relative to the total weight of the layer B, more preferably 75 wt % or more, even more preferably 90 wt % or more and ideally 100 wt %. According to one preferred embodiment, the layer B consists of a silica-based layer. It is preferably deposited by vacuum evaporation.

The layer B is preferably deposited without treatment by activated species, in particular without ion assistance.

The layer A preferably has a thickness ranging from 20 to 150 nm and more preferably from 25 to 120 nm. When it forms the external layer of the interference coating, the layer A preferably has a thickness ranging from 60 to 100 nm. When it forms the layer making direct contact with the external layer B of the interference coating, the layer A preferably has a thickness ranging from 20 to 100 nm and more preferably from 25 to 90 nm.

The layer B, when it is present, preferably has a thickness ranging from 2 to 60 nm and more preferably from 5 to 50 nm. When the layer B is present, the sum of the thicknesses of the layers A and B preferably ranges from 20 to 150 nm, more preferably from 25 to 120 nm an even more preferably from 60 to 100 nm.

Preferably, all the low refractive index layers of the interference coating according to the invention except for the layer A are inorganic in nature (i.e. the other low refractive index layers of the interference coating preferably do not contain any organic compounds).

Preferably, all the layers of the interference coating according to the invention except for the layer A are inorganic in nature, or in other words the layer A is preferably the only layer of organic nature in the interference coating of the invention (the other layers of the interference coating preferably containing no organic compounds).

Mechanical stresses are another property to take into account when designing interference coatings. The stress in the layer A is zero or negative. In the latter case the layer is under compression. This compressive stress preferably ranges from 0 to −500 MPa, more preferably from −20 to −500 MPa and even more preferably from −50 to −500 MPa. The optimal compressive stress ranges from −150 to −400 MPa and preferably from −200 to −400 MPa. It is measured at a temperature of 20° C. and under a relative humidity of 50% in the way described below. It is the deposition conditions of the invention that allow this stress to be achieved.

The principle of the stress measurement is based on the detection of deformation of a thin substrate. As the geometry and the mechanical properties of the substrate, its deformation and the thickness of the deposited layer are known, stress may be calculated using Stoney's formula. The stress σₜₒₜ is obtained by measuring the curvature of practically flat polished substrates made of (100) silicon or mineral glass before and after deposition of a monolayer according to the invention, or of a complete AR stack, on a face of a substrate having a very slight concavity, then by calculating the stress value using Stoney's formula:

$$σ = \frac{1}{6 R} \frac{{E}_{S} {d}_{S}^{2}}{( 1 - {v}_{S} ) {d}_{f}} \qquad ( 1 )$$

in which

$$\frac{{E}_{S}}{( 1 - {v}_{S} )}$$

is the biaxial elastic modulus of the substrate, dₛ is the thickness of the substrate (m), d_{f} is the thickness of the film (m), Eₛ is the Young's modulus of the substrate (Pa), vₛ is the Poisson coefficient of the substrate,
and

$$R = \frac{{R}_{1} {R}_{2}}{{R}_{1} - {R}_{2}} \qquad ( 2 )$$

where R₁ is the measured radius of curvature of the substrate before the deposition, and R₂ is the measured radius of curvature of the substrate coated with the film after the deposition.

The curvature is measured by means of a Tencor FLX 2900 (Flexus) apparatus. A Class IIIa laser with a power of 4 milliwatts (mW) at 670 nm is used for the measurement. The apparatus allows internal stresses to be measured as a function of time or temperature (maximum temperature of 900° C.).

The following parameters are used to calculate the stress:

Biaxial elastic modulus of Si: 180 GPa.

Thickness of the Si substrate: 300 microns.

Scan length: 40 mm.

Thickness of the deposited film (measured by ellipsometry): 200-500 nm.

The measurements are carried out at room temperature under air.

To determine the stress in an interference coating, the coating is deposited on a given suitable substrate and then the stress is measured as above.

The stress in the interference coating according to the invention generally ranges from 0 to −400 MPa, preferably from −50 to −300 MPa, more preferably from −80 to −250 MPa, and even more preferably from −100 to −200 MPa.

The layers A of the invention have elongations at break higher than those of inorganic layers and may therefore undergo deformations without cracking. Thus, the article according to the invention has a greater resistance to bending, as is demonstrated in the experimental section.

The critical temperature of a coated article according to the invention is preferably higher than or equal to 80° C., more preferably higher than or equal to 90° C., and even more preferably higher than or equal to 100° C. This high critical temperature is due to the presence of the layer A in the interference coating, as demonstrated in the experimental section. Without wanting to be limited to one interpretation of the invention, the inventors think that, apart from the nature of the layer, using layers A, since they allow compressive stress in the stack on the whole to be increased, improves the critical temperature of the article.

In the present application, the critical temperature of an article or a coating is defined as being that from which cracks are observed to appear in the stack present on the surface of the substrate, thereby degrading the interference coating.

Because of its improved thermomechanical properties, the interference coating of the invention may especially be applied to a single face of a semi-finished lens, generally its front face, the other face of this lens still needing to be machined and treated. The interference coating on the front face will not be degraded by temperature rises due to treatments to which the back face is subjected when coatings deposited on this back face are hardened or to any other action liable to increase the temperature of the lens.

According to one preferred embodiment, the interference coating of the invention contains, in the deposition order, on the surface of the optionally coated substrate, a ZrO₂ layer that is generally from 10 to 40 nm in thickness and preferably from 15 to 35 nm in thickness, an SiO₂ layer that is generally from 10 to 40 nm in thickness and preferably from 15 to 35 nm in thickness, a ZrO₂ or TiO₂ layer that is generally from 40 to 150 nm in thickness and preferably from 50 to 120 nm in thickness, and an ITO layer that is generally from 1 to 15 nm in thickness and preferably from 2 to 10 nm in thickness, and either a layer A according to the invention, which is generally from 50 to 150 nm in thickness and preferably from 60 to 100 nm in thickness, or a layer A according to the invention coated with a layer B according to the invention (in the second case, the sum of the thicknesses of the layers A and B will generally range from 50 to 150 nm and preferably from 60 to 100 nm).

Preferably, the average reflection factor in the visible domain (400-700 nm) of an article coated with an interference coating according to the invention, denoted Rₘ, is lower than 2.5% per face, preferably lower than 2% per face and even more preferably lower than 1% per face of the article. In one optimal embodiment, the article comprises a substrate the two main surfaces of which are coated with an interference coating according to the invention, and has a total Rₘ value (cumulative reflection due to the two faces) lower than 1%. Means for achieving such Rₘ values are known to those skilled in the art.

The light reflection factor Rᵥ of an interference coating according to the invention is lower than 2.5% per face, preferably lower than 2% per face, more preferably lower than 1% per face of the article, even more preferably ≤0.75%, and even more preferably ≤0.5%.

In the present application, the “average reflection factor” Rₘ (average of the spectral reflection over the entire visible spectrum between 400 and 700 nm) and the “light reflection factor” Rᵥ are such as defined in standard ISO 13666:1998 and measured according to standard ISO 8980-4.

The color coordinates of the article of the invention in the CIE L*a*b* color space are calculated between 380 and 780 nm with respect to illuminant D65 and the observer (angle of incidence: 10°). The interference coatings produced are not limited with regard to their hue angle. However, their hue angle h preferably ranges from 120 to 150°, thereby producing a coating having a residual green color in reflection, and their chroma C* is preferably lower than 15 and more preferably lower than 10.

The optical properties of the articles of the invention are stable over time. Preferably, their chroma C* does not vary by more than 1, more preferably by more than 0.5 over a period of 3 months after their production, i.e. from the moment they leave the chamber.

In some applications, it is preferable for the main surface of the substrate to be coated with one or more functional coatings prior to the deposition of the coating having silanol groups on its surface. These functional coatings, which are conventionally used in optics, may, without limitation, be a primer layer for improving the shock-resistance and/or adhesion of subsequent layers in the final product, an anti-abrasion and/or anti-scratch coating, a polarized coating, a photochromic coating or a tinted coating, and may in particular be a primer layer coated with an anti-abrasion and/or anti-scratch layer. The latter two coatings are described in greater detail in the patent applications WO 2008/015364 and WO 2010/109154.

The article according to the invention may also comprise coatings, formed on the interference coating, capable of modifying the surface properties of the interference coating, such as a hydrophobic coating and/or oleophobic coating (anti-smudge top coat) or an anti-fogging coating. These coatings are preferably deposited on the external layer of the interference coating. They are generally lower than or equal to 10 nm in thickness, preferably from 1 to 10 nm in thickness and more preferably from 1 to 5 nm in thickness. They are described in patent applications WO 2009/047426 and WO 2011/080472, respectively.

The hydrophobic and/or olephobic coating is preferably a fluorosilane or fluorosilazane coating. It may be obtained by deposition of a fluorosilane or fluorosilazane precursor preferably containing at least two hydrolysable groups per molecule. The fluorosilane precursors preferably contain fluoro polyether groups and more preferably per-fluoro polyether groups.

The external hydrophobic and/or oleophobic coating preferably has a surface energy of 14 mJ/m² or less, more preferably of 13 mJ/m² or less and even more preferably of 12 mJ/m² or less. The surface energy is calculated using the Owens-Wendt method described in the article: “Estimation of the surface force energy of polymers” Owens D. K., Wendt R. G. (1969), J. Appl. Polym. Sci., 13, 1741-1747.

Compounds the may be used to obtain such coatings are described in patents JP 2005-187936 et U.S. Pat. No. 6,183,872.

Commercially available compositions allowing hydrophobic and/or oleophobic coatings to be produced include the composition KY130® from Shinetsu or the composition OPTOOL DSX®, sold by DAI KIN INDUSTRIES.

Typically, an article according to the invention comprises a substrate coated in succession with an adhesion and/or anti-shock primer layer, an anti-abrasion and/or anti-scratch coating, an optionally antistatic interference coating according to the invention, and a hydrophobic and/or oleophobic coating.

### DETAILED DESCRIPTION OF THE INVENTION

The invention is illustrated in a nonlimiting way by the following examples. Unless otherwise indicated, refractive indices are given for a wavelength of 630 nm and T=20-25° C.

### EXAMPLES

### 1. General Procedures

The articles employed in the examples comprised a 65 mm-diameter ORMA® ESSILOR lens substrate with a power of −2.00 dioptres and a thickness of 1.2 mm, coated on its concave face with the anti-shock primer coating and the anti-scratch and anti-abrasion coating (hard coat) disclosed in the experimental section of the patent application WO 2010/109154, with an anti reflection coating and with the anti-smudge coating disclosed in the experimental section of patent application WO 2010/109154.

The layers of the antireflection coating were deposited, without heating the substrates, by vacuum evaporation optionally, when specified, assisted during the deposition by a beam of oxygen and possibly argon ions (evaporation source: electron gun).

The vacuum deposition reactor was a Leybold LAB 1100+ machine equipped with an electron gun for the evaporation of the precursor materials, with a thermal evaporator, with a KRI EH 1000 F ion gun (from Kaufman & Robinson Inc.) for use in the preliminary phase of (IPC) preparation of the surface of the substrate by argon ion bombardment and in the ion-assisted deposition (IAD) of the layer A or of other layers, and with a system for introducing liquid, which system was used when the precursor compound of the layer A was a liquid under standard temperature and pressure conditions (the case of OMCTS). This system comprised a tank for the liquid precursor compound of the layer A, a liquid flowmeter and a vaporizer that was located in the machine and that in use was raised to a temperature from 80-200° C. depending on the flow rate of the gaseous precursor, which preferably ranged from 0.1 to 0.8 g/min (the temperature was 180° C. for a flow rate of 0.3 g/min). The precursor vapor exited from a copper tube inside the machine, at a distance of about 50 cm from the ion gun. A flow of oxygen was introduced into the ion gun.

The layers A according to the invention were formed by evaporation under ion bombardment of octamethylcyclotetrasiloxane supplied by ABCR.

The layers B according to the invention, when they were present, were formed by evaporation of silica supplied by Optron Inc.

The thickness of the deposited layers was controlled in real time by means of a quartz microbalance. Unless otherwise indicated, the thicknesses mentioned are physical thicknesses. A number of samples of each glass were prepared.

### 2. Operating Modes

The method used to produce optical articles according to the invention comprised introducing the substrate coated with the primer coating and the anti-abrasion coating defined above into the vacuum deposition chamber, a primary pumping step, then a secondary pumping step lasting 400 seconds and allowing a secondary vacuum to be obtained (˜2×10⁻⁵ mbar, pressure read from a Bayard-Alpert gauge), a step of preheating the vaporizer to a given temperature (˜5 min), a step of activating the surface of the substrate with a beam of argon ions (IPC: 1 minute, 100 V, 1 A, the ion gun being stopped at the end of this step), then deposition by evaporation of the following inorganic layers using the electron gun until the desired thickness was obtained for each layer:
a 20 nm-thick ZrO₂ layer,
a 25 nm-thick SiO₂ layer,
a 80 nm-thick ZrO₂ layer,
a 6 nm-thick electrically conductive ITO layer deposited with oxygen-ion assistance,

The layer A was then deposited on the ITO layer in the following way.

The ion gun was then started with argon, oxygen was added in the ion gun, with a set flow rate, the desired anode current (3 A) was input and the OMCTS compound was introduced into the chamber (liquid flow rate set to 0.3 g/min) The OMCTS supply was stopped once the desired thickness had been obtained, then the ion gun was turned off.

In examples 1 and 3 to 7 (embodiment 1) an anti-smudge coating layer (top coat) (Optool DSX™ from Daikin) of about 5 nm was deposited directly on an 80 nm-thick layer A that formed the external layer of the antireflection coating.

In examples 2 and 8 to 13 (embodiment 2), a 5-40 nm-thick silica layer (layer B) was deposited on a 40-75 nm-thick layer A (in the same way as the already deposited 1st silica layer of the antireflection coating, without ion assistance) the sum of the thicknesses of the layers A and B being equal to 80 nm, then an anti-smudge coating layer (top coat) (Optool DSX™ from Daikin) of about 5 nm was deposited on this silica layer.

Lastly, a venting step was carried out.

Comparative example 1 differs from the stacks of embodiments 1 and 2 described above in that the layer A or the multilayer layer A+layer B is replaced by a silica layer of the same thickness (80 nm).

Comparative example 2 differs from examples 1 and 3 to 7 in that the external layer of the antireflection coating was formed by coevaporation of OMCTS (liquid flow rate set to 0.1 g/min) and silica (at fixed power, electron gun operated with an emission current of 60 mA under ion assistance). This external layer of the antireflection coating, which layer is obtained from an organic substance and an inorganic substance, is therefore prepared in accordance with the teachings of patent U.S. Pat. No. 6,919,134.

### 3. Characterizations

Colorimetric measurements of hue angle h* and chroma C* in the CIE (L*, a*, b*) space were carried out with a Zeiss spectrophotometer.

Abrasion resistance was evaluated by determining Bayer ASTM (Bayer sand) values for substrates coated with the antireflection coating and anti-smudge coating, using the methods described in patent application WO 2008/001011 (standard ASTM F 735.81). The higher the value obtained in the Bayer test, the higher the resistance to abrasion. Thus, the Bayer ASTM (Bayer sand) value was deemed to be good when it was higher than or equal to 3.4 and lower than 4.5 and excellent for values of 4.5 or more.

The qualitative test known as the “nx 10 blow” test allows the adhesion properties of a film deposited on a substrate to be evaluated, especially the adhesion of an antireflection coating to an ophthalmic lens substrate. It was carried out on the concave face of the lenses using the procedure described in international patent application WO 2010/109154.

The critical temperature of the article was measured in the way indicated in patent application WO 2008/001011. It was measured one week after production of the article.

Corrosion resistance was evaluated using a salt water (200 g/1) submersion test at 50° C. The glass was submerged for 20 min and then, after wiping, the visual appearance of the coating was evaluated. Delamination defects when present and changes in the color of the antireflection coating were especially taken into account. A mark of 1 corresponded to a slight change in color, a mark of 2 meant that no change was detectable.

The bending resistance test allowed the capacity of an article having a curvature to undergo a mechanical deformation to be evaluated.

The test was carried out on an initially spherical glass that was trimmed to the shape of a 50×25 mm rectangle.

The forces applied in this test were representative of the forces applied at an opticians when fitting the glass, i.e. when the glass is “compressed” in order to be inserted into a metal frame. This test used an Instron machine to controllably deform the glass, light-emitting diodes (LEDs) to illuminate the glass, a video camera and an image-analyzing software package. The coated glass was compressed by the Instron machine, by applying forces exerted along the axis of the main length of the trimmed glass until cracks appeared, perpendicular to the movement direction, in the antireflection coating, which cracks were detected by image analysis in transmission. The result of the test was the critical deformation D in mm that the glass can experience before cracks appear, see FIG. 1. This test was carried out one month after the glasses had been produced. The higher the value of the deformation, the better the resistance to applied mechanical deformation.

Generally, interference coatings according to the invention have critical deformation values ranging from 0.7 to 1.2 mm, preferably from 0.8 to 1.2 mm and more preferably from 0.9 to 1.2 mm.

### 4. Results

Table 1 below collates the optical performances of various antireflection coatings (the time t denotes the moment when production of the article ended).

TABLE 1

| | | | Ar/O2 | | | | | |
|---|---|---|---|---|---|---|---|---|
| | Layer A | Layer B | flow rate | | Hue | | | |
| | thickness | thickness | (ion gun) | | angle h | Chroma | Rₘ | Rᵥ |
| Example | (nm) | (nm) | (sccm) | Example | (°) | C* | (%) | (%) |
| 1 | 85 | 0 | 0/20 | 1 (t + 1 h) | 131 | 4.6 | 1.14 | 1.00 |
| | | | | 1 (t + 1 month) | 125 | 4.8 | 1.04 | 0.91 |
| | | | | Variation | −6 | +0.2 | −0.1 | −0.09 |
| 2 | 45 | 45 | 5/20 | 2 (t + 1 h) | 151 | 7.7 | 0.75 | 0.73 |
| | | | | 2 (t + 1 month) | 146 | 7.3 | 0.70 | 0.67 |
| | | | | Variation | −5 | −0.4 | −0.05 | −0.06 |
| Comp 1 | 0 | 80 | — | Comp 1 (t + 1 h) | 128 | 7.6 | 0.74 | 0.71 |
| | | | | Comp 1 (t + 1 | 123 | 5.3 | 0.67 | 0.58 |
| | | | | month) | | | | |
| | | | | Variation | −5 | −2.3 | −0.07 | −0.13 |

time t = moment when production of the article ended i.e. the moment when it was taken out of the deposition chamber.

Articles according to the invention have a better optical stability, in particular their chroma is much more stable over time. The article of comparative example 1 saw its chroma decrease by more than 2 over time, which is unacceptable.

Table 2 below indicates the thicknesses of the layers A and B for each of the examples 3 to 13, the deposition conditions of the layer A (respective flow rates of argon and O₂ in the ion gun) and the results of the tests to which the articles produced were subjected.

TABLE 2

| | | | | | | | Bending | |
|---|---|---|---|---|---|---|---|---|
| | | Layer B | Ar/O₂ | Layer A | | | resistance test, | |
| | Layer A | (SiO₂) | flow rate | refractive | | Critical | deformation in | |
| | thickness | thickness | (ion gun) | index at | Bayer | temperature | mm before | Corrosion |
| Example | (nm) | (nm) | (sccm) | 630 nm | sand | (° C.) | cracking | resistance |
| 3 | 80 | 0 | 0/14 | 1.54 | 5.6 | 110 | 0.85 | 1 |
| 4 | 80 | 0 | 0/20 | 1.53 | 6.9 | 103 | 0.95 | 1 to 2 |
| 5 | 80 | 0 | 0/25 | 1.50 | 6.5 | 83 | 0.72 | 1 |
| 6 | 80 | 0 | 5/20 | | 5.6 | 100 | | 1 |
| 7 | 80 | 0 | 10/20 | | 5.0 | 85 | | 1 to 2 |
| 8 | 75 | 5 | 0/20 | | 4.7 | 100 | 0.9 | 1 |
| 9 | 40 | 40 | 0/20 | | 4.8 | 88 | 0.94 | |
| 10 | 55 | 25 | 0/20 | | 5.4 | 95 | | 1 to 2 |
| 11 | 25 | 55 | 0/20 | | 4.3 | 80 | | 1 |
| 12 | 55 | 25 | 0/25 | | 4.7 | 80 | | 1 |
| 13 | 40 | 40 | 0/25 | | 4.5 | 75 | | 1 |
| Comp 1 | 0 | 80 | — | | 4.6 | 60-70 | 0.5 to 0.6 | 1 |

| | | | | | | | |
|---|---|---|---|---|---|---|---|
| Comp 2 | 80 (coevaporation) | 0/20 | 1.48 | 6.0 | 70 | 0.65 | Partial |
| | | | | | | | delamination |

The layer A of example 4 had the following atomic contents: 22% silicon, 40.8% oxygen, 20.5% carbon and 16.7% hydrogen. The external layer of the antireflection coating of comparative example 2, obtained by coevaporation of silica and OMCTS, had the following atomic contents: 28.2% silicon, 61.5% oxygen, 3% carbon and 10.3% hydrogen.

The articles according to the invention had a clearly improved critical temperature and exhibited a significant improvement in the bending deformation that the article could undergo before cracks appeared. These improvements are directly attributable to the presence of a layer A in the antireflection stack, as comparing the examples according to the invention to comparative example 1 shows.

Corrosion resistance is generally improved by the presence of a layer A.

The lenses of all the examples and comparative examples successfully passed the test commonly called the “n×10 blow” test. This showed that the various layers of the antireflection coating according to the invention had good adhesion properties, in particular at the interface with the substrate.

The inventors observed that embodiment 2 (examples 8-13) allowed an article to be obtained having a clearly more effective anti-smudge coating than that of the embodiment 1 (examples 3-7), as may be seen by carrying out the (“magic ink”) ink test described in patent application WO 2004/111691, while preserving good mechanical properties.

It was also noted that using argon ions in addition to oxygen ions in the ion beam improved the cosmetic aspect of the glasses by preventing surface defects, which defects were especially visible under an arc lamp, from appearing over time.

1-17. (canceled)

18. An article comprising a substrate having at least one main surface coated with a multilayer interference coating comprising an external layer, said multilayer interference coating containing a layer A having a refractive index lower than or equal to 1.55, wherein:
said layer A is:
either the external layer of the multilayer interference coating;
or an intermediate layer of the multilayer interference coating, making direct contact with the external layer of the multilayer interference coating, this external layer of the multilayer interference coating being a layer B having a refractive index lower than or equal to 1.55;
and said layer A was obtained by deposition of activated species issued from at least one compound C in gaseous form, containing in its structure at least one silicon atom, at least one carbon atom, at least one hydrogen atom and, optionally, at least one nitrogen atom and/or at least one oxygen atom, the deposition of said layer A being carried out by-applying a bombardment with an ion beam to layer A while layer A is being formed, and in the presence of nitrogen and/or oxygen when the compound C does not contain nitrogen and/or oxygen; and
said layer A is not formed from inorganic precursor compounds.

19. The article of claim 18, wherein the ion beam is emitted by an ion gun.

20. The article of claim 18, wherein the compound C contains at least one silicon atom bearing at least one alkyl group.

21. The article of claim 18, wherein the compound C contains at least one group of formula: 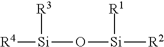
where R¹ to R⁴ independently designate alkyl groups.

22. The article of claim 18, wherein the compound C is chosen from octamethylcyclotetrasiloxane and hexamethyldisiloxane.

23. The article of claim 18, wherein the layer A does not contain a separate metal oxide phase.

24. The article of claim 18, further defined as possessing a layer B deposited on the layer A, the layer B containing at least 50 wt % silica relative to the total weight of the layer B.

25. The article of claim 24, wherein the layer B contains at least 100 wt % silica relative to the total weight of the layer B.

26. The article of claim 18, wherein the layer A has a thickness ranging from 20 to 150 nm.

27. The article of claim 26, wherein the layer A has a thickness ranging from 25 to 120 nm.

28. The article of claim 18, wherein the layer B has a thickness ranging from 2 to 60 nm.

29. The article of claim 18, wherein the multilayer interference coating contains low refractive index layers and all these low refractive index layers are inorganic except for the layer A.

30. The article of claim 18, wherein all the layers of the multilayer interference coating are inorganic, except for the layer A.

31. The article of claim 18, wherein the multilayer interference coating is an antireflection coating.

32. The article of claim 18, wherein the stress in the layer A ranges from 0 to −500 MPa.

33. The article of claim 18, wherein layer A is deposited without the assistance of a plasma at the substrate level.

34. The article of claim 18, wherein layer A has a refractive index higher than or equal to 1.47.

35. The article of claim 18, wherein said multilayer interference coating has a total thickness of less than 1 μm.

36. The article of claim 18, wherein layer A has a refractive index higher than or equal to 1.49.

37. A process for manufacturing the article of claim 18, comprising:
providing an article comprising a substrate having at least one main surface;
depositing, on said main surface of the substrate, a multilayer interference coating comprising an external layer, said multilayer interference coating containing a layer A having a refractive index lower than or equal to 1.55, which is:
either the external layer of the multilayer interference coating;
or an intermediate layer of the multilayer interference coating, making direct contact with the external layer of the multilayer interference coating, this external layer of the interference coating being a layer B having a refractive index lower than or equal to 1.55;
recovering an article comprising a substrate having a main surface coated with said multilayer interference coating that contains said layer A, wherein said layer A was obtained by deposition of activated species issued from at least one compound C in gaseous form, containing in its structure at least one silicon atom, at least one carbon atom, at least one hydrogen atom and, optionally, at least one nitrogen atom and/or at least one oxygen atom, the deposition of said layer A being carried out by ion bombardment, where an ion beam is applied to layer A while it is being formed, and in the presence of nitrogen and/or oxygen when the compound C does not contain nitrogen and/or oxygen, and in that the layer A is not formed from inorganic precursor compounds.
